(19) United States
(12) Patent Application Publication
(10) Pub. No.: US 2019/0064585 A1
(43) Pub. Date: Feb. 28, 2019

(54) SUBSTRATE FOR ELECTRO-OPTICAL DEVICE, ELECTRO-OPTICAL DEVICE, AND ELECTRONIC APPARATUS

(71) Applicant: SEIKO EPSON CORPORATION, Tokyo (JP)

(72) Inventor: Satoshi ITO, Eniwa-shi (JP)

(73) Assignee: SEIKO EPSON CORPORATION, Tokyo (JP)

(21) Appl. No.: 16/114,410

(22) Filed: Aug. 28, 2018

(30) Foreign Application Priority Data
Aug. 29, 2017 (JP) 2017-164030

(51) Int. Cl. G02F 1/1335; G02F 1/1362

(52) U.S. Cl. CPC G02F 1/133526; G02F 1/136209

(57) ABSTRACT

An element substrate of an electro-optical device (substrate for an electro-optical device) includes a lens between a first substrate (substrate body) and a semiconductor layer of a switching element. The lens overlap, in a plan view, with the pixel electrode. The lens includes a lens layer, which includes a silicon oxynitride film, and a barrier layer is disposed between the lens layer and the semiconductor layer. The barrier layer prevents nitrogen from escaping from the lens layer. For example, the barrier layer includes, for instance, a silicon nitride film stacked on the lens layer on an opposite side of the first substrate, and has a thickness of 10 nm or more.

The present application is based on and claims priority from JP Application Serial Number 2017-164030, filed Aug. 29, 2017, the disclosure of which is hereby incorporated by reference herein in its entirety.

### BACKGROUND

### 1. Technical Field

The disclosure relates to a substrate for an electro-optical device, the substrate including lenses formed on locations overlapping, in a plan view, with pixel electrodes. The disclosure also relates to an electro-optical device and an electronic apparatus.

### 2. Related Art

Electro-optical devices (liquid crystal devices) used as, for example, a light valve for a projection display apparatus include a liquid crystal layer disposed between an element substrate, which includes pixel electrodes and switching elements, and a counter substrate, which includes a common electrode. Such electro-optical devices display images by modulating, through the liquid crystal layer, light incident from one of the element substrate side or the counter substrate side. In the element substrate, only the light that reaches the light transmission regions (pixel aperture regions), which are surrounded by, for example, lines, contributes to the display. Hence, there is a proposal that, in an electro-optical device that receives light incident from the element substrate side, a plurality of lenses are formed on locations overlapping, in a plan view, with the plurality of respective pixel electrodes of the element substrate. Such a configuration makes it possible to display bright images (see JP-A-2015-34860). Likewise, in a case that light is incident from the counter substrate side, a plurality of lenses are formed on locations overlapping, in a plan view, with the plurality of respective pixel electrodes of the element substrate. Therefore, the inclination of light to be emitted from the element substrate can be reduced, and high-quality images can be displayed.

In JP-A-2015-34860, to provide lenses between the substrate body of the element substrate and the switching elements, concave curved surfaces are formed on the substrate body. Subsequently, a configuration is adopted such that the concavities of the concave curved surfaces are filled with a lens layer including a silicon oxynitride (SiON) film. Also proposed is that an optical path length-adjusting layer having substantially the same refractive index as the substrate body is disposed on a side of the lens layer on an opposite side of the substrate body. Although the material of the optical path length-adjusting layer is not explicitly disclosed, the optical path length-adjusting layer may include a silicon oxide (SiO₂) film since the substrate body is formed of a quartz substrate.

In the production process for the element substrate, lenses are formed while the element substrates are in the form of a mother substrate, which is larger than the element substrates, and thereafter a heat treatment at a temperature of approximately 1000° C. or higher is performed. For example, when forming switching elements or when forming semiconductor layers and gate insulating layers, a heat treatment at a temperature of approximately 1000° C. or higher is performed. As a result, nitrogen may escape from the silicon oxynitride film that constitutes the lens layer, and thus the silicon oxynitride film may shrink. Consequently, warping may occur in the mother substrate. Such warping may cause a difficulty in, for example, transportation in subsequent processes.

### SUMMARY

The disclosure provides a substrate for an electro-optical device, an electro-optical device, and an electronic apparatus, by which warping of a substrate body is prevented when a lens and a switching element are sequentially formed on the substrate body.

According to an aspect of the disclosure, a substrate for an electro-optical device includes a first substrate, a pixel electrode on a first surface of the first substrate, a switching element between the first substrate and the pixel electrode, the switching element including a semiconductor layer, a lens between the first substrate and the semiconductor layer, the lens overlapping, in a plan view, with the pixel electrode and having a surface covered with a lens layer, and a barrier layer between the lens and the semiconductor layer, the barrier layer having a higher density than the lens layer.

According to the disclosure, when a heat treatment at a temperature of approximately 1000° C. or higher is performed in a switching element formation step, a barrier layer is already provided between the lens layer and the semiconductor layer. Hence, even in the heat treatment, escape of components from the lens layer is reduced by the barrier layer, and thus a situation in which the lens layer shrinks is less likely to occur. Thus, the occurrence of warping in the first substrate is prevented. Consequently, a situation in which the lens layer shrinks as a result of escape of components from the lens layer is less likely to occur, and thus the occurrence of warping in the first substrate can be reduced.

According to another aspect of the disclosure, the lens layer may include a silicon oxynitride film, and the barrier layer prevents escape of nitrogen form the lens layer. According to such an aspect, when a heat treatment at a temperature of approximately 1000° C. or higher is performed in the switching element formation step, the barrier layer is already provided between the lens layer and the semiconductor layers. Hence, even when the heat treatment is performed, escape of nitrogen from the lens layer is prevented by the barrier layer. Thus, a situation in which the lens layer shrinks as a result of escape of nitrogen is less likely to occur, and consequently, the occurrence of warping in the first substrate can be prevented.

According to another aspect of the disclosure, the barrier layer may include one of a silicon nitride film, an aluminum oxide film, or a hafnium oxide film. According to another aspect of the disclosure, the barrier layer may include a silicon nitride film. According to such an aspect, part of the source gas for forming the silicon oxynitride film can also be used as a source gas for forming the barrier layer.

According to another aspect of the disclosure, the barrier layer may be stacked on at least a surface of the lens layer on an opposite side of the first substrate. According to such an aspect, escape of nitrogen from the lens layer can be effectively prevented.

According to another aspect of the disclosure, the substrate may further include a light shielding layer between the lens layer and the semiconductor layer, and the barrier layer may be disposed at least between the light shielding layer and the semiconductor layers.

According to another aspect of the disclosure, the barrier layer may have a thickness of at least 10 nm.

According to another aspect of the disclosure, the substrate may further include an anti-reflection film between the lens layer and the pixel electrodes, and the anti-reflection film may include a multi-layer dielectric film including the barrier layer.

An electro-optical device including the substrate for an electro-optical device applying to another aspect of the disclosure may include a counter substrate including a second substrate and a common electrode, and an electro-optical layer. The second substrate faces the substrate for the electro-optical device. The common electrode is on a surface of the second substrate, the surface facing the substrate for the electro-optical device. The electro-optical layer is disposed between the substrate for the electro-optical device and the counter substrate.

The electro-optical device according to the disclosure is used in a variety of electronic apparatuses. According to the disclosure, in a case that the electro-optical device is used in a projection display apparatus, among other electro-optical apparatuses, the projection display apparatus includes a light source unit configured to emit light to be supplied to the electro-optical device and a projection optical system configured to project light modulated by the electro-optical device.

### BRIEF DESCRIPTION OF THE DRAWINGS

Embodiments of the disclosure will be described with reference to the accompanying drawings, wherein like numbers reference like elements.

FIG. 1 is a plan view of an electro-optical device to which the disclosure is applied.

FIG. 2 is a cross-sectional view of the electro-optical device illustrated in FIG. 1.

FIG. 3 is a plan view of a plurality of adjacent pixels in the electro-optical device illustrated in FIG. 1.

FIG. 4 is an F-F′ cross-sectional view of the electro-optical device illustrated in FIG. 3.

FIG. 5 is a diagram schematically illustrating, in cross section, a configuration of lenses of the electro-optical device illustrated in FIG. 1.

FIG. 6 is a diagram illustrating a positional relationship, in a plan view, between the lenses and light shielding layers, of the electro-optical device illustrated in FIG. 1.

FIG. 7 is a diagram illustrating a mother substrate used for production of the element substrate of the electro-optical device illustrated in FIG. 1.

FIG. 8 is a cross-sectional view illustrating steps of a method for producing the element substrate of the electro-optical device illustrated in FIG. 1.

FIG. 9 is a diagram illustrating a barrier layer of an electro-optical device according to Exemplary Embodiment 2 of the disclosure.

FIG. 10 is a diagram illustrating a barrier layer of an electro-optical device according to Exemplary Embodiment 3 of the disclosure.

FIG. 11 is a diagram illustrating a barrier layer of an electro-optical device according to Exemplary Embodiment 4 of the disclosure.

FIG. 12 is a diagram illustrating a barrier layer of an electro-optical device according to Exemplary Embodiment 5 of the disclosure.

FIG. 13 is a diagram illustrating a barrier layer of an electro-optical device according to Exemplary Embodiment 6 of the disclosure.

FIG. 14 is a diagram illustrating a barrier layer of an electro-optical device according to Exemplary Embodiment 7 of the disclosure.

FIG. 15 is a diagram illustrating a barrier layer of an electro-optical device according to Exemplary Embodiment 8 of the disclosure.

FIG. 16 is a schematic configuration diagram of a projection display apparatus (electronic apparatus) utilizing an electro-optical device to which the disclosure is applied.

### DESCRIPTION OF EXEMPLARY EMBODIMENTS

Exemplary embodiments of the disclosure will be described with reference to the accompanying drawings. In the drawings that will be referenced in the following description, in order to make each of the layers, members, and the like recognizable in terms of size, the layers, members, and the like are not drawn to scale. In addition, in the following description, when layers formed in the element substrate are described, the term “upper” (“over”) or “front” refers to the side opposite the side on which the substrate is located (side on which the counter substrate is located), and the term “lower” (“under”) refers to the side on which the substrate is located.

### Exemplary Embodiment 1

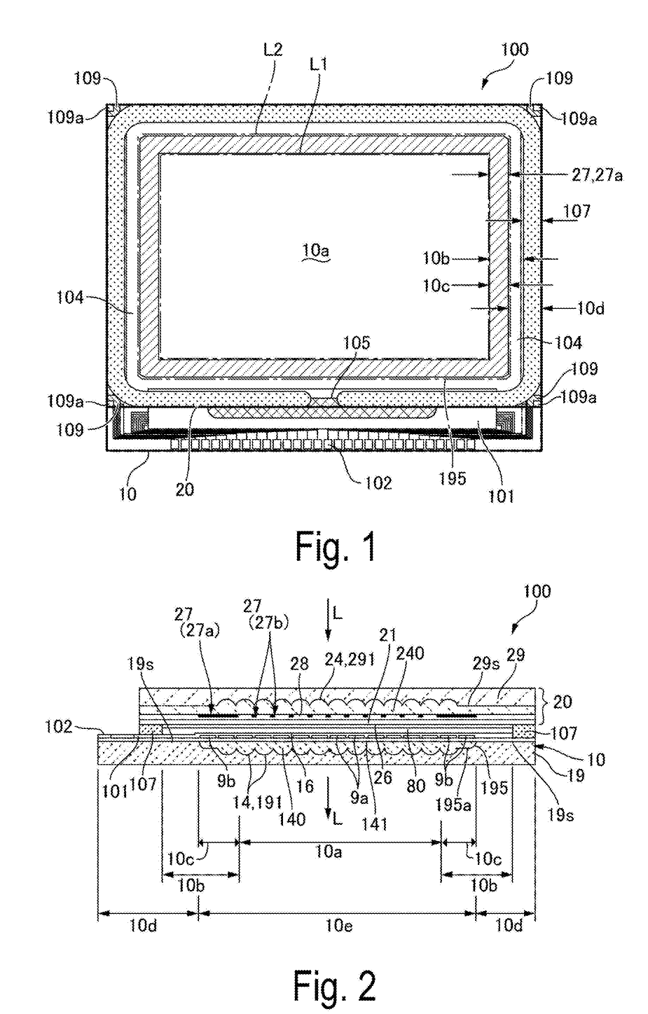

Configuration of Electro-Optical Device FIG. 1 is a plan view of an electro-optical device 100 according to Exemplary Embodiment 1 of the disclosure. FIG. 2 is a cross-sectional view of the electro-optical device 100 illustrated in FIG. 1. As illustrated in FIGS. 1 and 2, the electro-optical device 100 includes an element substrate 10 and a counter substrate 20, which are bonded together via a sealing member 107, with a predetermined gap in between. Thus, the element substrate 10 and the counter substrate 20 face each other. The sealing member 107 is disposed in a frame shape along the outer edge of the counter substrate 20. An electro-optical layer 80 is disposed in the region surrounded by the sealing member 107, between the element substrate 10 and the counter substrate 20. Examples of the electro-optical layer 80 include liquid crystal layers. Thus, the electro-optical device 100 is configured as a liquid crystal device. The sealing member 107 is a photocurable adhesive or a photocurable and thermosetting adhesive and contains a gap material for providing a distance of a predetermined value between the two substrates. Examples of the gap material include glass fibers and glass beads. The element substrate 10 and the counter substrate 20 each have a quadrilateral shape. A display region 10a, which is an area of a quadrilateral shape, is disposed at a substantially central position of the electro-optical device 100. To correspond to such shapes, the sealing member 107 is also disposed in a substantially quadrilateral shape. A peripheral region 10b, which has a rectangular frame shape, is disposed between the inner peripheral edge of the sealing member 107 and the outer peripheral edge of the display region 10a.

The element substrate 10 includes a first substrate 19, which serves as a substrate body and which is light transmissive, such as quartz substrates and glass substrates. On a first surface 19s side, which is closer to the counter substrate 20, of the first substrate 19, a data line drive circuit 101 and a plurality of terminals 102 are arranged outside the display region 10a, along one side of the element substrate 10. A scan line drive circuit 104 is formed along another side that is adjacent to the one side. A flexible printed circuit (not illustrated) is coupled to the terminals 102. Various electric potentials and various signals are input to the element substrate 10 via the flexible printed circuit.

On the first surface 19s of the first substrate 19, in the display region 10a, a plurality of pixel electrodes 9a and switching elements (not illustrated in FIG. 2) are formed in a matrix form. The plurality of pixel electrodes 9a each include an indium tin oxide (ITO) film and the like, and are light transmissive. The switching elements are electrically coupled to the plurality of pixel electrodes 9a respectively. A first alignment film 16 for the pixel electrodes 9a is formed to be closer to the counter substrate 20. The pixel electrodes 9a are covered with the first alignment film 16.

The counter substrate 20 includes a second substrate 29, which serves as a substrate body and is light transmissive, such as quartz substrates and glass substrates. On a first surface 29s side of the second substrate 29, facing the element substrate 10, a common electrode 21 is formed, and a second alignment film 26 is formed on the element substrate 10 side with respect to the common electrode 21. The common electrode 21 includes, for example, an ITO film and is light transmissive. The common electrode 21 is formed on substantially the entirety of the second substrate 29 and covered with the second alignment film 26. Light shielding layers 27 each having a light-shielding property are formed on the first surface 29s side of the second substrate 29, on an opposite side of the element substrate 10, with respect to the common electrode 21. The light shielding layers 27 include a resin, metal, or a metal compound.

The light shielding layers 27 include a parting portion 27a, which has a frame shape extending along the outer peripheral edge of the display region 10a. The light shielding layers 27 also include light shielding layers 27b, which are located on regions overlapping, in a plan view, with regions each of which is sandwiched between adjacent ones of the pixel electrodes 9a. In an exemplary embodiment, the peripheral region 10b of the element substrate 10 includes a dummy pixel region 10c, which overlaps, in a plan view, with the parting portion 27a. Dummy pixel electrodes 9b are formed simultaneously with the pixel electrodes 9a, in the dummy pixel region 10c.

The first alignment film 16 and the second alignment film 26 are inorganic alignment films (vertical alignment films) each including an obliquely-deposited film that may include, for example, SiOₓ (x<2), SiO₂, TiO₂, MgO, or Al₂O₃. The first alignment film 16 and the second alignment film 26 cause the liquid crystal molecules used in the electro-optical layer 80 to be obliquely aligned. The liquid crystal molecules have negative dielectric anisotropy. Thus, the liquid crystal molecules have a predetermined angle with respect to the element substrate 10 and the counter substrate 20. As described, the electro-optical device 100 is configured as a liquid crystal device of the vertical alignment (VA) mode.

The element substrate 10 includes inter-substrate electrical conducting electrodes 109 at regions overlapping with the corners of the counter substrate 20 at outer sides of the sealing member 107. The inter-substrate electrical coupling electrodes 109 are provided to establish electrical continuity between the element substrate 10 and the counter substrate 20. An inter-substrate electrical coupling member 109a, which includes electrically conductive particles, are deposited at the inter-substrate electrical coupling electrode 109. The common electrode 21 of the counter substrate 20 is electrically coupled to the element substrate 10 side via the inter-substrate electrical coupling members 109a and the inter-substrate electrical coupling electrodes 109. Thus, a common electric potential is applied to the common electrode 21 from the element substrate 10 side.

In the electro-optical device 100 according to an exemplary embodiment, the pixel electrodes 9a and the common electrode 21 each include a light-transmissive electrically conductive film, such as an ITO film. The electro-optical device 100 is configured as a transmissive liquid crystal device. In the electro-optical device 100, while light passes through one of the element substrate 10 or the counter substrate 20, and enters the electro-optical layer 80, then passes through the other of the substrates, and is emitted, the light is modulated to display images. In an exemplary embodiment, as indicated by an arrow L, while light enters the counter substrate 20 and passes through the element substrate 10, and is then emitted, the light is modulated by the electro-optical layer 80 for each of the pixels and an image is displayed.

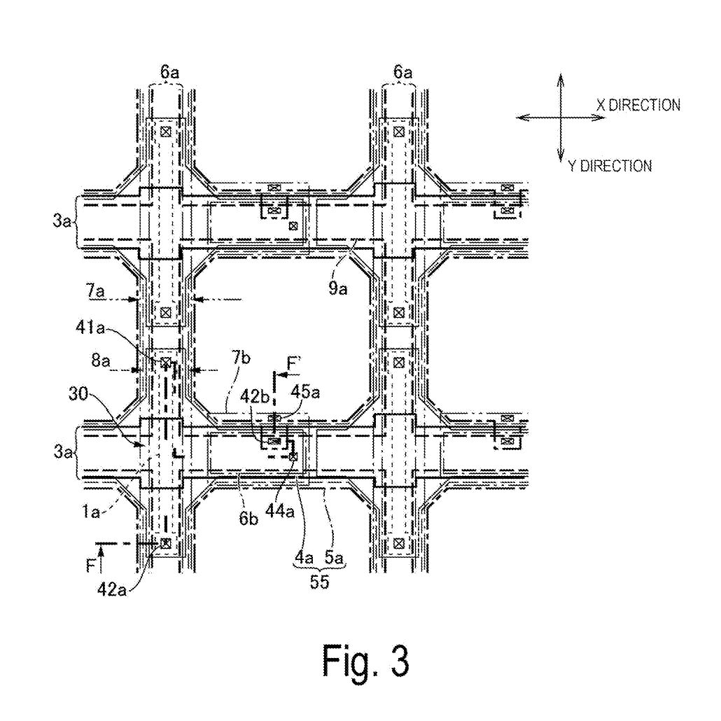

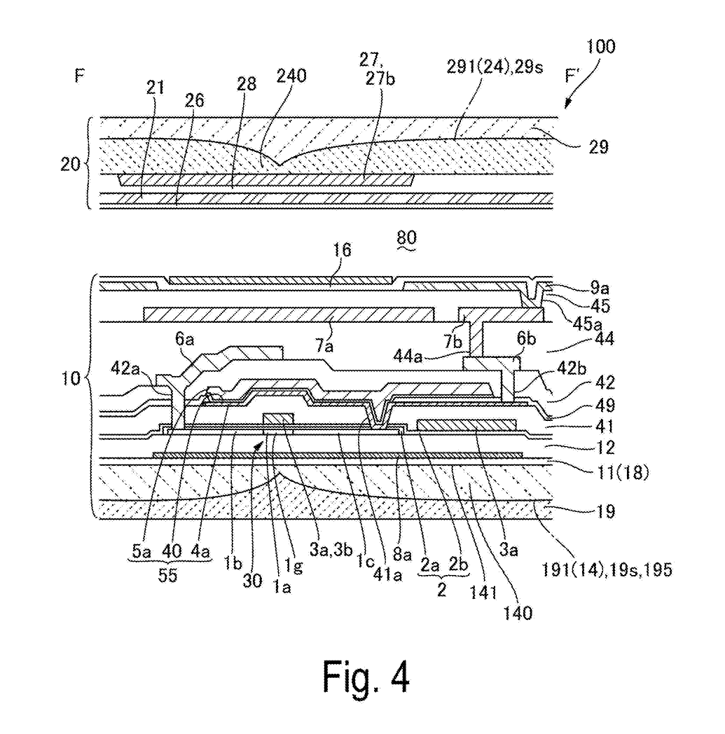

Specific Configuration of Pixels FIG. 3 is a plan view of a plurality of adjacent pixels in the electro-optical device 100 illustrated in FIG. 1. FIG. 4 is an F-F′ cross-sectional view of the electro-optical device 100 illustrated in FIG. 3. In FIG. 3, the layers are indicated by the lines described below. In addition, in FIG. 3, layers of which ends overlap with each other in a plan view are drawn such that the ends are displaced relative to each other to clearly illustrate, for example, shapes of the layers.

Lower light shielding layer 8a: long thin dashed line

Semiconductor layer 1a: short thin dotted line

Scan line 3a: thick solid line

Drain electrode 4a: thin solid line

Data line 6a and relay electrode 6b: thin dash-dot line

Capacitance line 5a: thick dash-dot line

Upper light shielding layer 7a and relay electrode 7b: thin dash-dot-dot line.

Pixel electrode 9a: thick dashed line

As illustrated in FIG. 3, the pixel electrodes 9a are formed on a surface, facing the counter substrate 20, of the element substrate 10. The pixel electrodes 9a are formed for a plurality of respective pixels. Data lines 6a and scan lines 3a are formed along inter-pixel regions each of which is sandwiched between adjacent ones of the pixel electrodes 9a. The inter-pixel regions each extend in a vertical or transverse direction. The scan lines 3a extend linearly along first inter-pixel regions, which extend in an X-direction, of the inter-pixel regions. The data lines 6a extend linearly along second inter-pixel regions, which extend in a Y-direction. In addition, switching elements 30 are formed corresponding to the intersections between the data lines 6a and the scan lines 3a. In an exemplary embodiment, the switching elements 30 are formed by utilizing intersection regions of the data lines 6a and the scan lines 3a and the vicinities. The capacitance line 5a is formed in the element substrate 10. A common electric potential Vcom is applied to the capacitance line 5a. The capacitance line 5a is formed in a lattice form and extends overlapping the scan lines 3a and the data lines 6a. An upper light shielding layer 7a is formed above the switching elements 30. The upper light shielding layer 7a extends overlapping the data lines 6a and the scan lines 3a. A lower light shielding layer 8a is formed under the switching elements 30. The lower light shielding layer 8a extends overlapping the scan lines 3a and the data lines 6a.

In the element substrate 10, a light transmissive layer 11, which is light transmissive, is formed on the first surface 19s of the first substrate 19. The lower light shielding layer 8a is formed on the light transmissive layer 11. The lower light shielding layer 8a includes an electrically conductive film including electrically conductive polysilicon films, metal silicide films, metal films, and metal compound films. The lower light shielding layer 8a includes a light shielding film including, for example, tungsten silicide (WSi), tungsten, or titanium nitride and prevents an occurrence of a malfunction in the switching elements 30, due to photocurrent, which may be caused by light entering into semiconductor layers 1a. In some cases, the lower light shielding layer 8a may be configured as scan lines. In such cases, the lower light shielding layer 8a is configured to be electrically coupled to gate electrodes 3b, which will be described later.

Above the first substrate 19, an insulating film 12, which is light transmissive, is formed on the lower light shielding layer 8a, and the switching elements 30, each of which includes the semiconductor layer 1a, are formed on the insulating film 12. The switching element 30 includes the semiconductor layer 1a and the gate electrode 3b. The semiconductor layer 1a is disposed with its longitudinal direction parallel to the extension direction of the data line 6a. The gate electrode 3b extends in a direction orthogonal to the longitudinal direction of the semiconductor layer 1a and overlaps with a central portion of the semiconductor layer 1a in the longitudinal direction. In an exemplary embodiment, the gate electrode 3b partially includes the scan line 3a. The switching element 30 includes a gate insulating layer 2, which is light transmissive, between the semiconductor layer 1a and the gate electrode 3b. The semiconductor layer 1a includes a channel region 1g, a source region 1b, and a drain region 1c. The channel region 1g faces the gate electrode 3b with the gate insulating layer 2 interposed between the channel region 1 g and the gate electrode 3b. The source region 1b and the drain region 1c are disposed on the opposite sides of the channel region 1g. In an exemplary embodiment, the switching element 30 has an LDD structure. Thus, the source region 1b and the drain region 1c each include a lightly doped region on each side of the channel region 1g, and each include a heavily doped region in a region adjacent to the lightly doped region on an opposite side of the channel region 1g.

The semiconductor layer 1a includes, for example, a polysilicon film (polycrystalline silicon film). The gate insulating layer 2 is a two-layer structure including a first gate insulating layer 2a and a second gate insulating layer 2b. The first gate insulating layer 2a includes a silicon oxide film obtained by thermally oxidizing the semiconductor layer 1a. The second gate insulating layer 2b includes a silicon oxide film formed by, for example, low-pressure CVD. The gate electrode 3b and the scan line 3a include an electrically conductive film, such as an electrically conductive polysilicon film, a metal silicide film, a metal film, and a metal compound film.

An interlayer insulating film 41 is formed over the gate electrodes 3b, and drain electrodes 4a are formed over the interlayer insulating film 41. The interlayer insulating film 41 includes, for example, a silicon oxide film and is light transmissive. The drain electrode 4a includes an electrically conductive film such as an electrically conductive polysilicon film, a metal silicide film, a metal film, and a metal compound film. The drain electrode 4a is arranged partially overlapping with the drain region 1c of the semiconductor layer 1a. The drain electrode 4a is electrically conductive with the drain region 1c via a contact hole 41a, which extends through the interlayer insulating film 41 and the gate insulating layer 2.

An etching stopper layer 49 and a dielectric layer 40 are formed over the drain electrode 4a. The etching stopper layer 49 includes, for example, a silicon oxide film and is light transmissive. The dielectric layers 40 are light transmissive. The capacitance line 5a is formed on the dielectric layers 40. The dielectric layer 40 may include a silicon compound film of a silicon oxide film and a silicon nitride film, or may be a dielectric layer having a high dielectric constant, such as an aluminum oxide film, a titanium oxide film, a tantalum oxide film, a niobium oxide film, a hafnium oxide film, a lanthanum oxide film, and a zirconium oxide film. The capacitance line 5a includes an electrically conductive film such as an electrically conductive polysilicon film, a metal silicide film, a metal film, or a metal compound film. The capacitance line 5a overlaps with the drain electrodes 4a, with the dielectric layers 40 interposed between the capacitance line 5a and the drain electrodes 4a, and constitutes a holding capacitance 55.

An interlayer insulating film 42 is formed on the capacitance line 5a. The interlayer insulating film 42 includes, for example, a silicon oxide film and is light transmissive. The data lines 6a and relay electrodes 6b are formed on the interlayer insulating film 42, and are each formed of the same electrically conductive film. The date line 6a and the relay electrode 6b include an electrically conductive film, such as an electrically conductive polysilicon film, a metal silicide film, a metal film, and a metal compound film. The data lines 6a are electrically coupled to the respective source regions 1b via respective contact holes 42a, which extend through the interlayer insulating film 42, the etching stopper layer 49, the interlayer insulating film 41, and the gate insulating layer 2. The relay electrodes 6b are electrically coupled to the respective drain electrodes 4a via respective contact holes 42b, which extend through the interlayer insulating film 42 and the etching stopper layer 49.

An interlayer insulating film 44 is formed on the data lines 6a and the relay electrodes 6b. The interlayer insulating film 44 includes, for example, a silicon oxide film and is light transmissive. The upper light shielding layer 7a and relay electrodes 7b are formed on the interlayer insulating film 44. The upper light shielding layer 7a and the relay electrodes 6b are each formed of the same electrically conductive film. The surface of the interlayer insulating film 44 is planarized. The upper light shielding layer 7a and the relay electrode 7b include an electrically conductive film, such as an electrically conductive polysilicon film, a metal silicide film, a metal film, or a metal compound film. The relay electrodes 7b are electrically coupled to the respective relay electrodes 6b via respective contact holes 44a, which extend through the interlayer insulating film 44. The upper light shielding layer 7a extends overlapping with the data lines 6a. The upper light shielding layer 7a may be electrically coupled to the capacitance line 5a to be utilized as a shield layer.

An interlayer insulating film 45 is formed on the upper light shielding layer 7a and the relay electrodes 7b. The interlayer insulating film 45 includes, for example, a silicon oxide film and is light transmissive. The pixel electrodes 9a are formed on the interlayer insulating film 45. The pixel electrode 9a includes, for example, an ITO film. Contact holes 45a are arranged in the interlayer insulating film 45 and reach the respective relay electrodes 7b. The pixel electrodes 9a are electrically coupled to the respective relay electrodes 7b via the respective contact holes 45a. As a result, the pixel electrodes 9a are electrically coupled to the respective drain regions 1c via the relay electrode 7b, the relay electrode 6b, and the drain electrode 4a. The surface of the interlayer dielectric film 45 is planarized. The first alignment film 16 is formed on the surface of the pixel electrodes 9a. The first alignment film 16 includes, for example, polyimide or an inorganic alignment film and is light transmissive.

Configuration of Lens 24 of Counter Substrate 20 Side

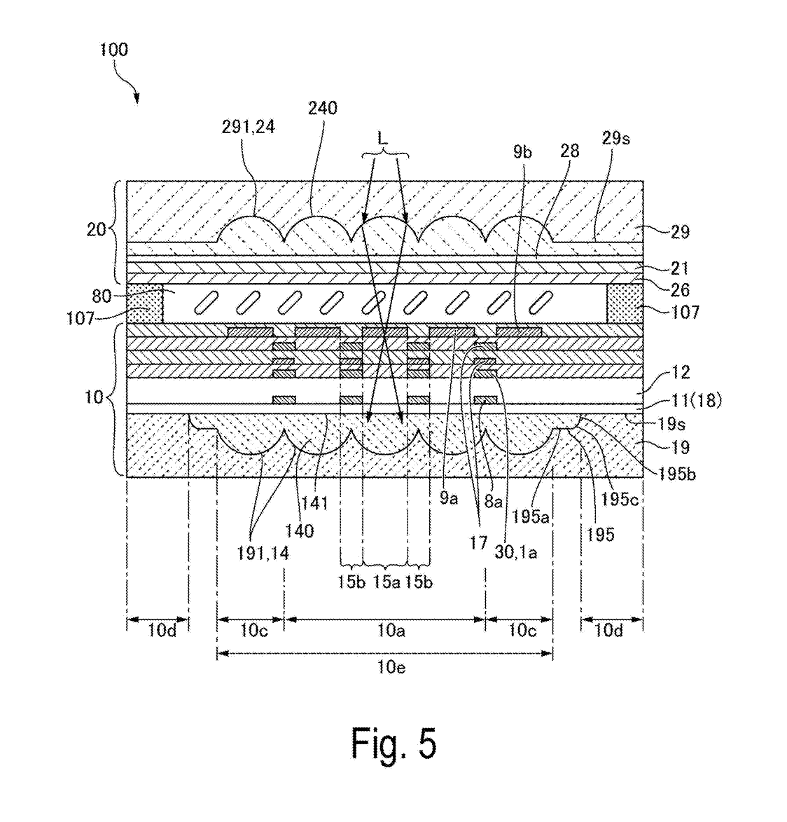

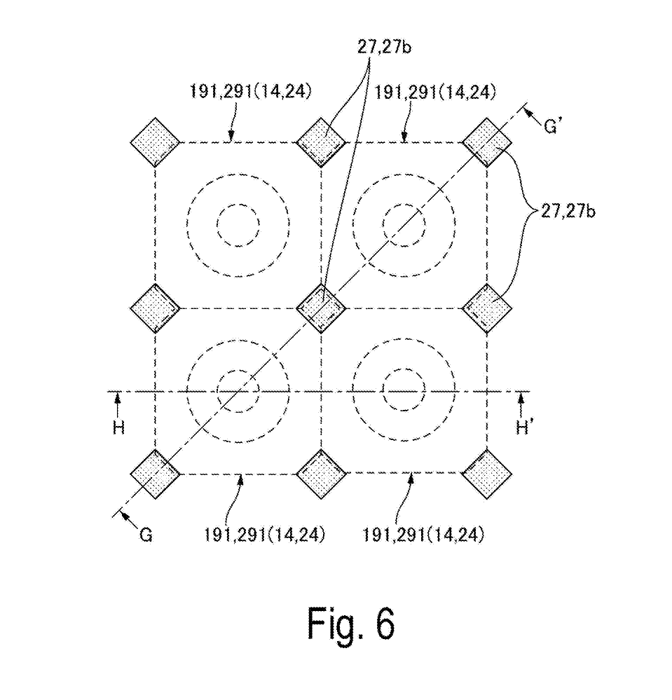

FIG. 5 is a diagram schematically illustrating, in cross section, configurations of lenses 14 and 24 of the electro-optical device 100 illustrated in FIG. 1. FIG. 6 is a diagram illustrating a positional relationship, in a plan view, between lenses 14 and 24 and light shielding layers 27b, of the electro-optical device 100 illustrated in FIG. 1.

As illustrated in FIG. 5, the element substrate 10 includes light shielding layers 17 and the switching elements 30, on the first surface 19s of the first substrate 19. The light shielding layers 17 include, for example, the data lines 6a. The light shielding layers 17 and the switching elements 30 are not light transmissive. Thus, in the regions overlapping, in a plan view, with the pixel electrodes 9a in the element substrate 10, regions overlapping, in a plan view, with the light shielding layers 17 or the switching elements 30 and regions overlapping, in a plan view, with the regions sandwiched between adjacent ones of the pixel electrodes 9a serve as light shielding regions 15b, which are not light transmissive. On the other hand, in the regions overlapping, in a plan view, with the pixel electrodes 9a, regions not overlapping, in a plan view, with the light shielding layers 17 or the switching elements 30 serve as aperture regions 15a (light transmissive regions), which are light transmissive. Thus, light passing through the aperture regions 15a contributes to displaying of images, whereas light traveling toward the light shielding regions 15b does not contribute to the displaying of images.

In an exemplary embodiment, a plurality of lenses 24 are formed in the counter substrate 20. The plurality of lenses 24 overlap, in a plan view, with the plurality of respective pixel electrodes 9a in a one-to-one relationship. The lenses 24 guide light traveling toward the light shielding layers 17 or the switching elements 30 to the aperture regions 15a. In addition, the lenses 24 collimate the light entering the electro-optical layer 80. Consequently, an inclination of the optical axis of the light entering the electro-optical layer 80 is small. Thus, a phase shift in the electro-optical layer 80 is reduced, and a decrease in transmittance and the contrast is prevented. In an exemplary embodiment, particularly, the electro-optical device 100 is configured as a VA-mode liquid crystal device. Hence, a decrease in the contrast, for example, tends to occur depending on the inclination of the optical axis of the light entering the electro-optical layer 80. With this exemplary embodiment, however, a decrease in the contrast, for example, is less likely to occur.

As illustrated in FIG. 6, the lenses 24 are arranged in such a manner that adjacent ones of the lenses 24 are at least partially in contact with one another. In an exemplary embodiment, each of the lenses 24 is in contact, along the entire periphery, with adjacent ones of the lenses 24. The light shielding layer 27b, which are illustrated in FIG. 2, is formed on a region overlapping, in a plan view, with a region surrounded by four lenses 24. Thus, although the light shielding layers 27b are illustrated in FIG. 2, which illustrates a cross section along line G-G′ of FIG. 6, the light shielding layers 27b are not illustrated in FIG. 5, which illustrates a cross section along line H-H′ of FIG. 6.

In a configuration of such a counter substrate 20, a plurality of lens surfaces 291, each of which includes a concave curved surface, are formed on the first surface 29s of the second substrate 29. The plurality of lens surfaces 291 overlap, in a plan view, with a plurality of respective pixel electrodes 9a in a one-to-one relationship. Further, a lens layer 240, which is light transmissive, and a protective layer 28, which is light transmissive, are stacked sequentially on the first surface 29s of the second substrate 29. The common electrode 21 is formed on an opposite side of the second substrate 29 with respect to the protective layer 28. The lens layer 240 has a refractive index different from the refractive index of the second substrate 29. The lens surfaces 291 and the lens layer 240 constitute the lenses 24. In an exemplary embodiment, the refractive index of the lens layer 240 is greater than the refractive index of the second substrate 29. For example, the second substrate 29 includes a quartz (silicon oxide, SiO₂) substrate and has a refractive index of 1.48, and the lens layer 240 includes a silicon oxynitride (SiON) film and has a refractive index of from 1.58 to 1.68. Thus, the lenses 24 have a positive power (positive refractive power) for converging light from a light source.

Configuration of Lens 14 of Element Substrate 10

As illustrated in FIG. 5, in an exemplary embodiment, a plurality of lenses, 14, are also formed in the element substrate 10, as in the counter substrate 20. The plurality of lenses 14 overlap, in a plan view, with the plurality of respective pixel electrodes 9a in a one-to-one relationship. The lenses 14 collimate the light that is emitted from the element substrate 10. Consequently, in an exemplary embodiment, for example, optical vignetting in a projection optical system is less likely occur in a projection display apparatus, which will be described later. Consequently, a bright display is achieved.

As illustrated in FIG. 6, the lenses 14 are arranged in such a manner that adjacent ones of the lenses 14 are at least partially in contact with one another, as with the lenses 24. In an exemplary embodiment, each of the lenses 14 is in contact, along the entire periphery, with adjacent ones of the lenses 14.

To configure such an element substrate 10, a plurality of lens surfaces 191, each of which includes a concave curved surface, are formed on the first surface 19s of the first substrate 19. The plurality of lens surfaces 191 overlap, in a plan view, with the plurality of respective pixel electrodes 9a in a one-to-one relationship. Further, a lens layer 140, which is light transmissive, is stacked on the first surface 19s of the first substrate 19 to cover the lens surfaces 191. The light transmissive layer 11, the lower light shielding layer 8a, the insulating film 12, and the like are arranged sequentially on an opposite side of the first substrate 19 with respect to the lens layer 140. The light transmissive layer 11 and the insulating film 12 constitute an optical path length-adjusting layer for adjusting an optical path length. The lens layer 140 has a refractive index different from the refractive index of the first substrate 19. The lens surfaces 191 and the lens layer 140 constitute the lenses 14. In an exemplary embodiment, the refractive index of the lens layer 140 is greater than the refractive index of the first substrate 19. For example, the first substrate 19 includes a quartz (silicon oxide, SiO₂) substrate and has a refractive index of 1.48, and the lens layer 140 includes a silicon oxynitride (SiON) film and has a refractive index of from 1.58 to 1.68. Thus, the lenses 14 have a positive power (positive refractive power) for converging light.

The first substrate 19 includes a recess 195 in the first surface 19s. The recess 195 is recessed across the entirety of the lens formation region 10e, and the plurality of lens surfaces 191 are arranged. The plurality of lens surfaces 191 are disposed on the bottom 195a of the recess 195. Thus, the lens layer 140 is provided to fill the interior of the recess 195. A surface 141 of the lens layer 140, on an opposite side of the first substrate 19, constitutes a flat surface continuous with the outer region 10d located on an outer side of the recess 195, on the first surface 19s of the first substrate 19. Thus, the outer region 10d of the first substrate 19 does not include the lens layer 140. In an exemplary embodiment, the lenses 14 are formed on locations overlapping with the pixel electrodes 9a in the display region 10a and locations overlapping with the dummy pixel electrodes 9b in the dummy pixel region 10c. Thus, the lens formation region 10e includes the display region 10a and the dummy pixel region 10c. The recess 195 is formed in a region including the display region 10a and the dummy pixel region 10c.

In an exemplary embodiment, a concave curved surface 195c is present between a side surface 195b and the bottom 195a, of the recess 195. The side surface 195b and the bottom 195a, of the recess 195, constitute a continuous surface and are connected to each other.

Method for Producing Electro-Optical Device 100

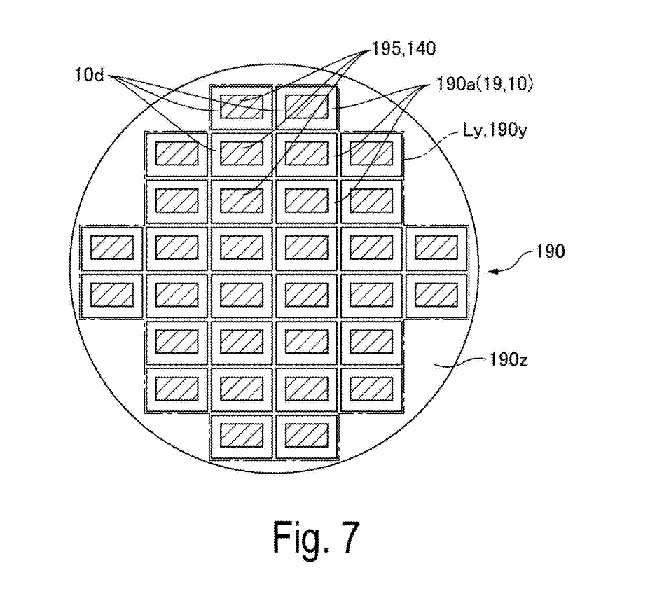

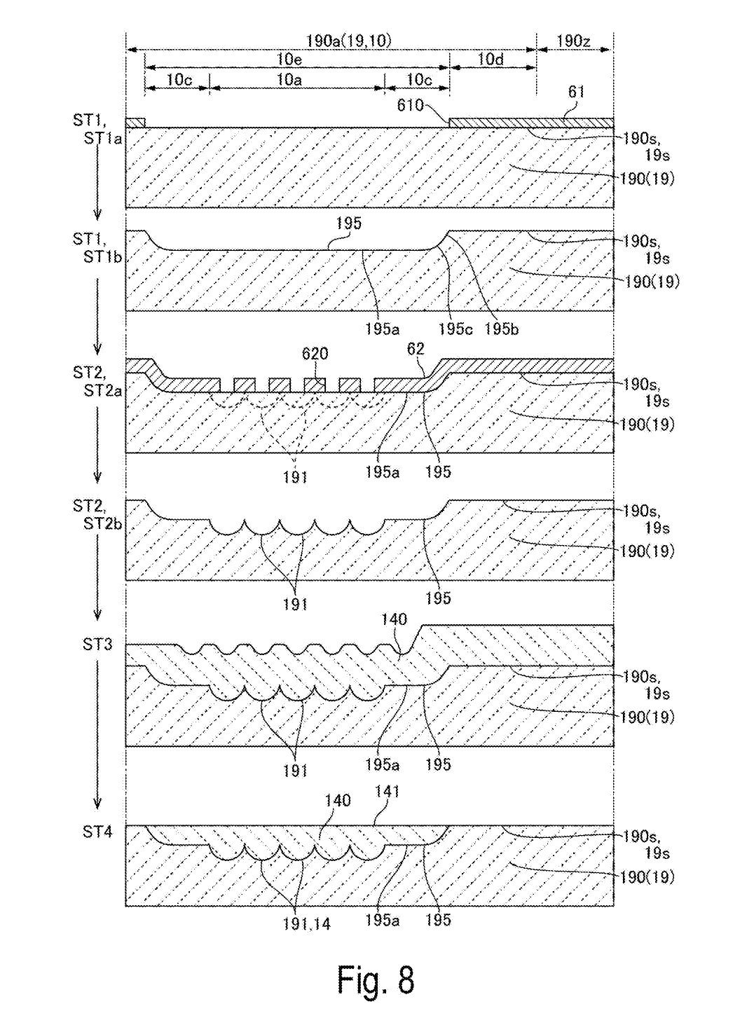

FIG. 7 is a diagram illustrating a mother substrate 190, which is used for production of the element substrate 10 of the electro-optical device 100 illustrated in FIG. 1. FIG. 8 is a cross-sectional view illustrating steps of a method for producing the element substrate 10 of the electro-optical device 100 illustrated in FIG. 1.

As illustrated in FIG. 7, the mother substrate 190 is used to produce the element substrate 10 in an exemplary embodiment. The mother substrate 190 includes a quartz substrate larger than the first substrate 19. The mother substrate 190 includes a plurality of regions 190a, which are to be diced into element substrates 10 (first substrates 19). The lenses 14, the switching elements 30, the pixel electrodes 9a, and other constituents, which are described above with reference to, for example, FIG. 2, are formed in each of the regions 190a. Thereafter, the mother substrate 190 is diced along the regions 190a to obtain the element substrate 10 of the individual substrate size. Thus, in the mother substrate 190, the region that is to be diced into a plurality of element substrates 10 (region surrounded by a dash-dot line Ly) is an effective region 190y, and the regions other than the effective region 190y constitute an excess material region 190z, which is to be removed in a dicing process.

In an exemplary embodiment, following steps are performed to produce the element substrate 10 from the mother substrate 190.

Recess formation step ST1

Lens surface formation step ST2

Lens layer formation step ST3

Planarization step ST4

Pixel Formation Step

First, in a recess formation step ST1, illustrated in FIG. 8, a recess 195 is formed in a first surface 190s (first surface 19s) of the mother substrate 190 (first substrate 19). More specifically, in a mask formation step ST1a, an etching mask 61 is formed over the first surface 190s of the mother substrate 190. In an exemplary embodiment, the pixel electrode 9a and the dummy pixel region 10c correspond to the lens formation region 10e, and the etching mask 61 includes an opening 610 corresponding to the lens formation region 10e. Next, in an etching step ST1b, the first surface 190s of the mother substrate 190 is etched through the opening 610 of the etching mask 61 to form the recess 195. Thereafter, the etching mask 61 is removed. As a result, as indicated by the hatched regions in FIG. 7, the recesses 195 are independently formed in the respective regions 190a, which are to be diced into the plurality of element substrates 10. The etching step ST1b may be carried out by wet etching or by dry etching. In an exemplary embodiment, in the etching step ST1b, wet etching is performed by using an etchant containing hydrofluoric acid. As a result, the concave curved surface 195c is formed between the side surface 195b and the bottom 195a, of the recess 195. The side surface 195b and the bottom 195a, of the recess 195, form a continuous surface and are connected to each other.

Next, in a lens surface formation step ST2, the plurality of lens surfaces 191, each including a concave curved surface, are formed on the bottom 195a of the recess 195. Specifically, in a mask formation step ST2a, an etching mask 62 is formed over the first surface 190s of the mother substrate 190. The etching mask 62 includes openings 620, which correspond to regions overlapping, in a plan view, with the centers of the respective lens surfaces 191. Next, in an etching step ST2b, isotropic etching is performed on the bottom 195a of the recess 195 through the openings 620. As a result, the lens surfaces 191, each including a concave curved surface, are formed on the first surface 190s of the mother substrate 190. The center of each of the lens surfaces 191 corresponds to the opening 620. Thereafter, the etching mask 62 is removed. The etching step ST2b may be carried out by wet etching or by dry etching. In an exemplary embodiment, in the etching step ST2b, wet etching is performed by using an etchant containing hydrofluoric acid.

Next, in a lens layer formation step ST3, the lens layer 140, which is light transmissive, is formed to fill the interior of each of the recesses 195 in the first surface 190s of the mother substrate 190. In an exemplary embodiment, the lens layer 140 includes a silicon oxynitride (SiON) film formed by, for example, plasma CVD.

Next, in a planarization step ST4, the lens layer 140 is planarized from an opposite side of the mother substrate 190, so that the surface 141 of the lens layer 140 on an opposite side of the mother substrate 190 constitutes a flat surface continuous with the surface of the outer region 10d, which is located outside the recess 195, on the first surface 190s of the mother substrate 190. As a result, the lens layer 140 is removed from the regions other than the recess 195. Consequently, as indicated by the hatched regions in FIG. 7, the lens layer 140 is independently formed within the recess 195 in each of the regions that are to be diced into the plurality of element substrates 10. In an exemplary embodiment, chemical mechanical polishing (CMP), for example, is used to perform the planarization process. In the process, portions, formed on the outer region 10d outside of the recess 195, of the lens layer 140 may be thinned. Then, the surface of the lens layer 140 remaining on the region overlapping with the recess 195 (lens formation region 10e) and on the outer region 10d may be planarized. In this manner, the portions of the lens layer 140 may be removed from the outer region 10d.

Subsequently, as illustrated in FIG. 4, the light transmissive layer 11 and the like are formed on the first surface 19s of the first substrate 19. Then, in a pixel formation step, elements, such as the plurality of switching elements 30 and the plurality of pixel electrodes 9a, are formed. Subsequently, after the mother substrate 190 and the counter substrate 20 are bonded together, the electro-optical layer 80 is injected between the mother substrate 190 and the counter substrate 20. Thereafter, the mother substrate 190 is diced.

Configuration of Barrier Layer 18

As described above, in the element substrate 10 (substrate for an electro-optical device) in an exemplary embodiment, as illustrated in FIGS. 4 and 5, the switching elements 30 each including the semiconductor layer 1a are formed between the first substrate 19 and the pixel electrodes 9a. The lenses 14 are disposed between the first substrate 19 and the semiconductor layers 1a to overlap, in a plan view, with the pixel electrodes 9a. In an exemplary embodiment, the barrier layer 18 is disposed between the lens layer 140 and the semiconductor layers 1a. The barrier layer 18 has a higher density than the lens layer 140 and is light transmissive. When the lens layer 140 is heated, the barrier layer 18 prevents components from escaping from the lens layer 140. In an exemplary embodiment, the lens layer 140 includes a silicon oxynitride film. Thus, when the lens layer 140 is heated, the barrier layer 18 prevents nitrogen from escaping from the lens layer 140. The barrier layer 18 may include layers including a silicon nitride film, an aluminum oxide film, or a hafnium oxide film. In an exemplary embodiment, the light transmissive layer 11 is configured as the barrier layer 18. The light transmissive layer 11 is stacked on a surface of the lens layer 140 on an opposite side of the first substrate 19. In an exemplary embodiment, the light transmissive layer 11 (barrier layer 18) includes a silicon nitride film, and the thickness of the barrier layer 18 is 10 nm or more. The insulating film 12 includes a silicon oxide film.

The barrier layer 18 may be formed across the entirety of the first surface 19s of the first substrate 19 or may be formed in at least the display region 10a, indicated by a dash-dot line L1 in FIG. 1. In an exemplary embodiment, the lenses 14 are also formed for the dummy pixel region 10c, which overlap, in a plan view, with the parting portion 27a. Thus, the barrier layer 18 may be formed in at least the region indicated by a dash-dot line L2 in FIG. 1 (display region 10a and dummy pixel region 10c). In an exemplary embodiment, however, since the lens layer 140 is disposed outside the display region 10a and the dummy pixel region 10c, the barrier layer 18 may be formed to overlap with the entirety of the lens layer 140. This effectively prevents nitrogen escaping from the lens layer 140. In an exemplary embodiment, the barrier layer 18 is formed across the entirety of the first surface 19s of the first substrate 19.

Major Advantages of Exemplary Embodiments

As described above, in the element substrate 10 and in the electro-optical device 100, in some exemplary embodiments, the semiconductor layers 1a (polysilicon film) of the switching elements 30, the first gate insulating layer 2a (thermal oxide film) are formed. Even when a heat treatment at a temperature of approximately 1000° C. or higher is performed for forming the above films, the barrier layer 18 is already present between the lens layer 140 and the semiconductor layers 1a, on the first substrate 19. Hence, even when a heat treatment is performed, escape of nitrogen (component of the lens layer 140) from the lens layer 140 is prevented by the barrier layer 18. Thus, a situation in which the lens layer 140 shrinks as a result of escape of nitrogen is less likely occur. Consequently, an occurrence of warping in the first substrate 19 (mother substrate 190) is prevented. Consequently, in steps subsequent to the heat treatment, a situation in which a difficulty in, for example, transporting the mother substrate 190 is less likely occur.

In particular, in an exemplary embodiment, the light transmissive layer 11, which is stacked on a surface of the lens layer 140 on an opposite side of the first substrate 19 is configured as the barrier layer 18 including a silicon nitride film. Thus, escape of nitrogen from the lens layer 140 is efficiently reduced. In addition, since the light transmissive layer 11, which is stacked on a surface of the lens layer 140 on an opposite side of the first substrate 19 is configured as the barrier layer 18 including a silicon nitride film. Hence, even in a case that, after the surface of the lens layer 140 is planarized, heating and planarization are performed again to prevent deformation of the lens layer 140 that may occur when a heat treatment is performed in a subsequent step, escape of nitrogen from the lens layer 140 is prevented by the barrier layer 18. Furthermore, since the barrier layer 18 includes a silicon nitride film, part of the source gas for forming the silicon oxynitride film can also be used as a source gas for forming the barrier layer.

In an exemplary embodiment, the recess 195 is formed in the first surface 19s of the first substrate 19, and the plurality of lens surfaces 191 are disposed on the bottom of the recess 195. The lens layer 140 is disposed to fill the interior of the recess 195. The surface 141 of the lens layer 140 on an opposite side of the first substrate 19 constitutes a continuous flat surface with the surface of the outer region 10d on the first surface 19s of the first substrate 19. The outer region 10d is located outside the recess 195. The outer region 10d does not include the lens layer 140. Thus, the regions where the lens layers 140 are formed are limited in the mother substrate 190, illustrated in FIG. 7. Thus, the lens layers 140 are formed separately from one another, on a plurality of locations, although the lens layer 140 has a significant variation in film thickness. Hence, a significant stress is is less likely to occur in the lens layer 140 even when a heat treatment is performed in the step of forming the switching elements 30 and the like. Consequently, an occurrence of cracking in the lens layer 140 is prevented, and an occurrence of, for example, delamination of the lens layer 140 from the first substrate 19, which may be caused by cracking, is prevented.

In addition, as the recess 195 is formed by wet etching, the concave curved surface 195c is provided between the side surface 195b and the bottom 195a, of the recess 195. Thus, a significant stress is less likely occur in the lens layer 140 even when a heat treatment is performed in the step of forming the switching elements 30 and the like. Consequently, an occurrence of cracking in the lens layer 140 is prevented, and an occurrence of, for example, delamination of the lens layer 140 from the first substrate 19, which may be caused by cracking, is prevented.

In addition, adjacent lens surfaces 191 of the plurality of lens surfaces 191 are at least partially connected to one another. In particular, in an exemplary embodiment, each of the plurality of lens surfaces 191 is connected, along the entire periphery, to lens surfaces 191 located around the lens surface. This configuration increases the amount of light entering the lens surfaces 191. When adjacent lens surfaces 191 are connected to one another, the lens layer 140 is formed across a large area of the first substrate 19. In an exemplary embodiment, however, the lens layer 140 is disposed in the interior of the recess 195. Thus, a stress is less likely to occur in the lens layer 140, even in a case that a heat treatment is performed in the step of forming the switching elements 30 and the like.

### Exemplary Embodiment 2

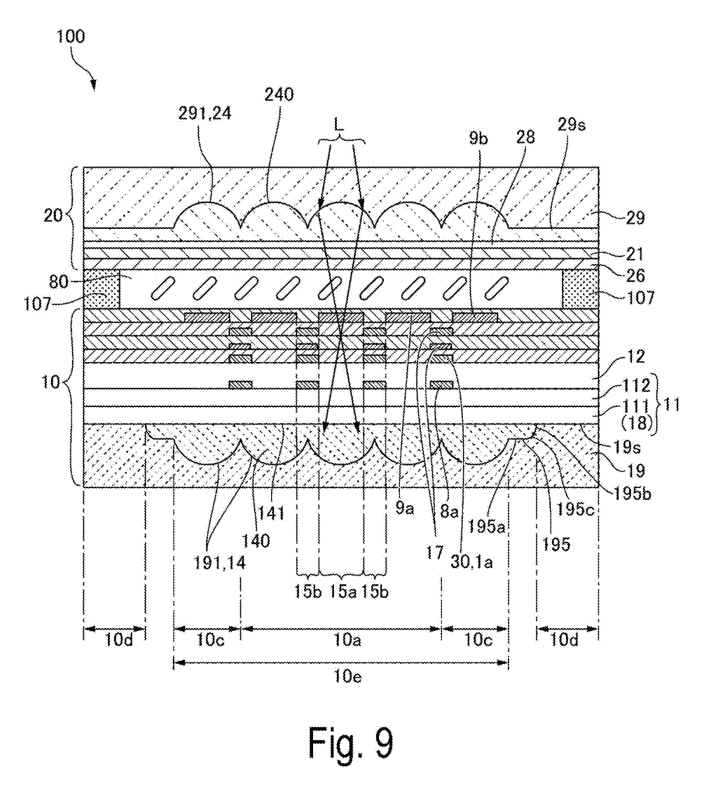

FIG. 9 is a diagram illustrating the barrier layer 18 of the electro-optical device 100 according to Exemplary Embodiment 2 of the disclosure. Note that the general configurations of Exemplary Embodiment 2 and Exemplary Embodiments to be described later are similar to the general configuration of Exemplary Embodiment 1, and thus like parts are designated by like reference characters, and a description of such parts is omitted. In Exemplary Embodiment 1, the light transmissive layer 11 includes a single layer of the barrier layer 18, whereas, in Exemplary Embodiment 2, a multi-layer film including the barrier layer 18 is formed between the lens layer 140 and the lower light shielding layer 8a. More specifically, in Exemplary Embodiment 2, as illustrated in FIG. 9, the light transmissive layer 11 is formed between the lens layer 140 and the lower light shielding layer 8a, and the light transmissive layer 11 includes a multi-layer film including a first layer 111 and a second layer 112. The second layer 112 is stacked on an opposite side of the first substrate 19 with respect to the first layer 111. The second layer 112 includes a silicon oxide film. The first layer 111 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 3

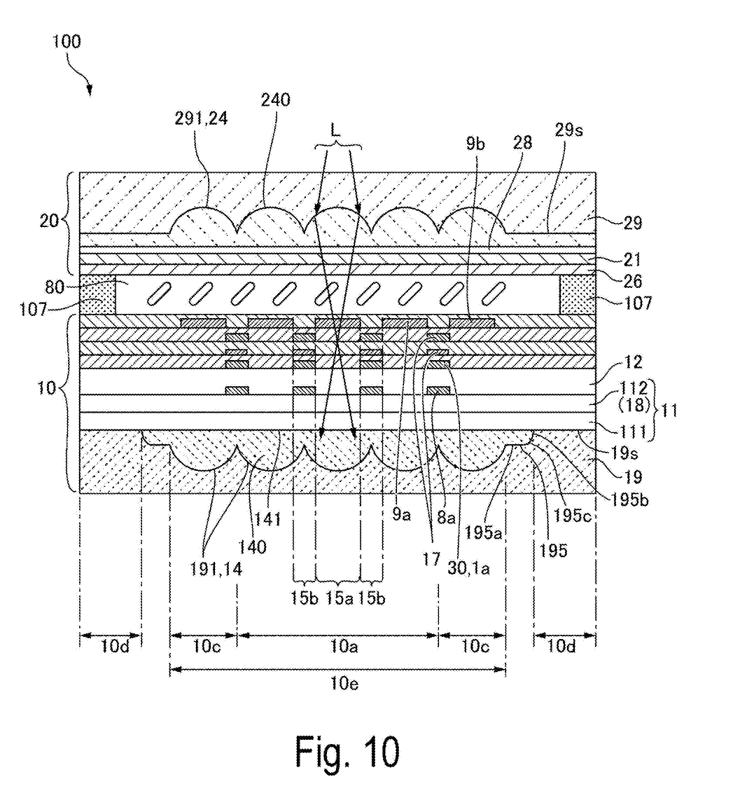

FIG. 10 is a diagram illustrating the barrier layer 18 of the electro-optical device 100 according to Exemplary Embodiment 3 of the disclosure. In Exemplary Embodiment 3, as illustrated in FIG. 10, the light transmissive layer 11 is formed between the lens layer 140 and the lower light shielding layer 8a, and the light transmissive layer 11 includes a multi-layer film including a first layer 111 and a second layer 112. The second layer 112 is stacked on an opposite side of the first substrate 19 with respect to the first layer 111. The first layer 111 includes a silicon oxide film. The second layer 112 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 4

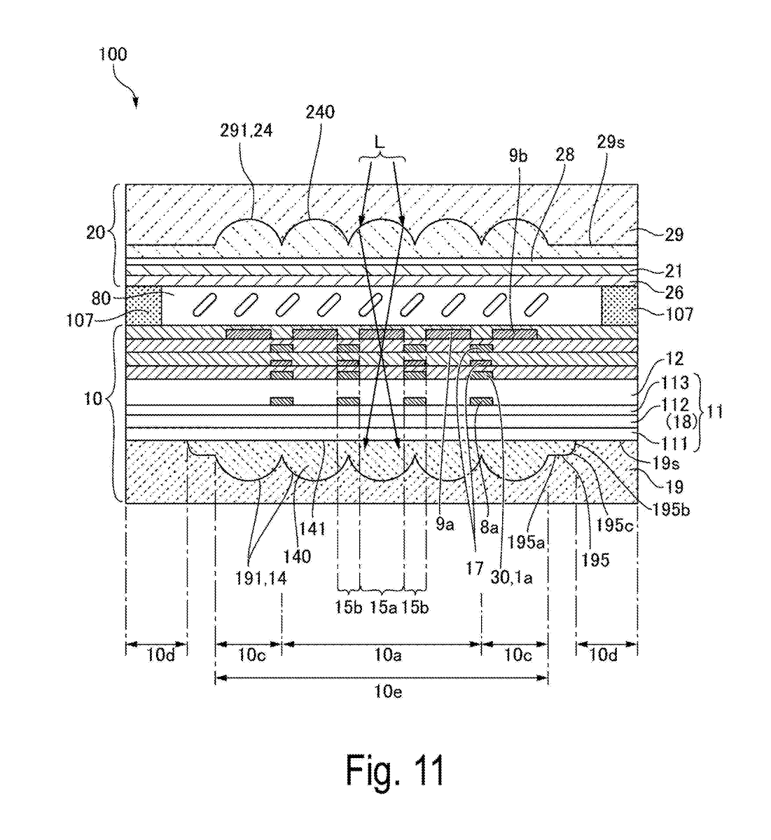

FIG. 11 is a diagram illustrating the barrier layer 18 of the electro-optical device 100 according to Exemplary Embodiment 4 of the disclosure. In Exemplary Embodiment 4, as illustrated in FIG. 11, the light transmissive layer 11 is formed between the lens layer 140 and the lower light shielding layer 8a, and the light transmissive layer 11 includes stacked films including a first layer 111, a second layer 112, and a third layer 113. The second layer 112 is stacked on an opposite side of the first substrate 19 with respect to the first layer 111. The third layer 113 is stacked on an opposite side of the first substrate 19 with respect to the second layer 112. The first film 111 and the third film 113 each include a silicon oxide film. The second layer 112 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 5

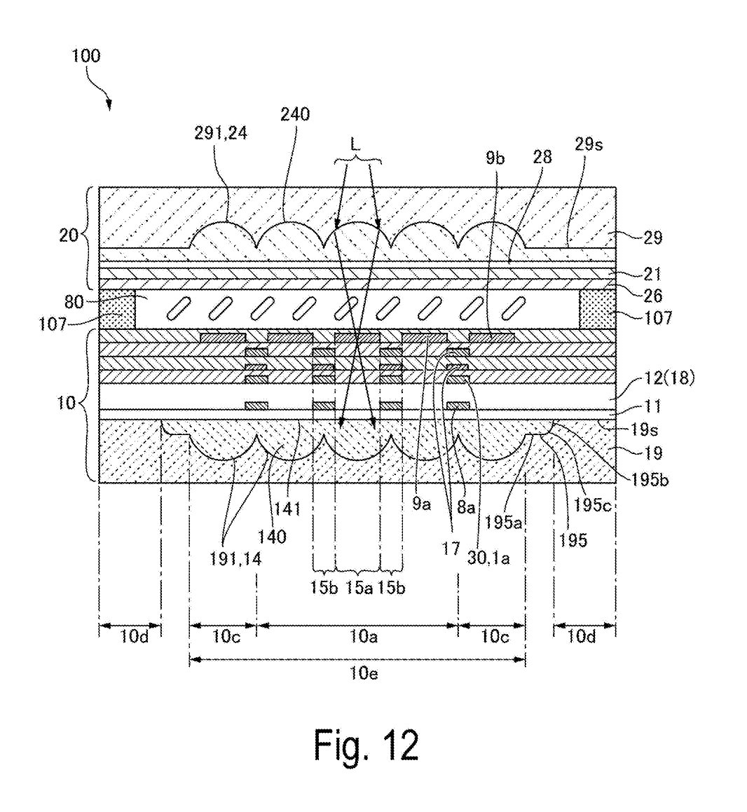

FIG. 12 is a diagram illustrating the barrier layer 18 of the electro-optical device 100 according to Exemplary Embodiment 5 of the disclosure. In Exemplary Embodiment 1, the barrier layer 18 is disposed between the lens layer 140 and the lower light shielding layer 8a. In contrast, in Exemplary Embodiment 5, as illustrated in FIG. 12, the barrier layer 18 is disposed between the lower light shielding layer 8a and the semiconductor layers 1a. The light transmissive layer 11 includes a silicon oxide film. More specifically, the insulating film 12, which is formed between the lower light shielding layer 8a and the semiconductor layers 1a, includes a silicon nitride film and serves as the barrier layer 18. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 6

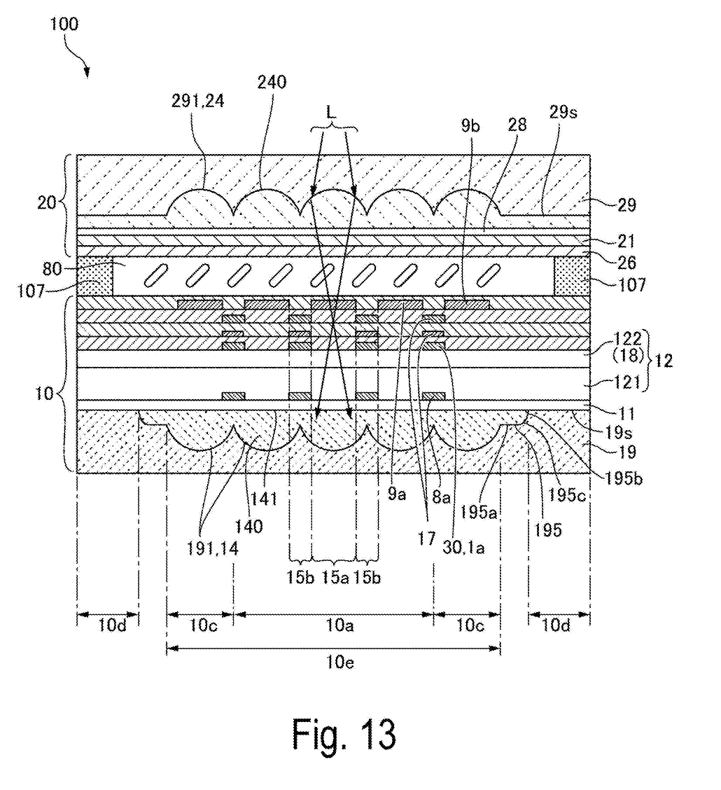

FIG. 13 is a diagram illustrating the barrier layer 18 of the electro-optical device 100 according to Exemplary Embodiment 6 of the disclosure. As illustrated in FIG. 13, in Exemplary Embodiment 6, the insulating film 12, which is formed between the lower light shielding layer 8a and the semiconductor layers 1a, includes stacked films including a first layer 121 and a second layer 122. The second layer 122 is stacked on an opposite side of the first substrate 19 with respect to the first layer 121. The first layer 121 and the light transmissive layer 11 each include a silicon oxide film. The second layer 122 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 7

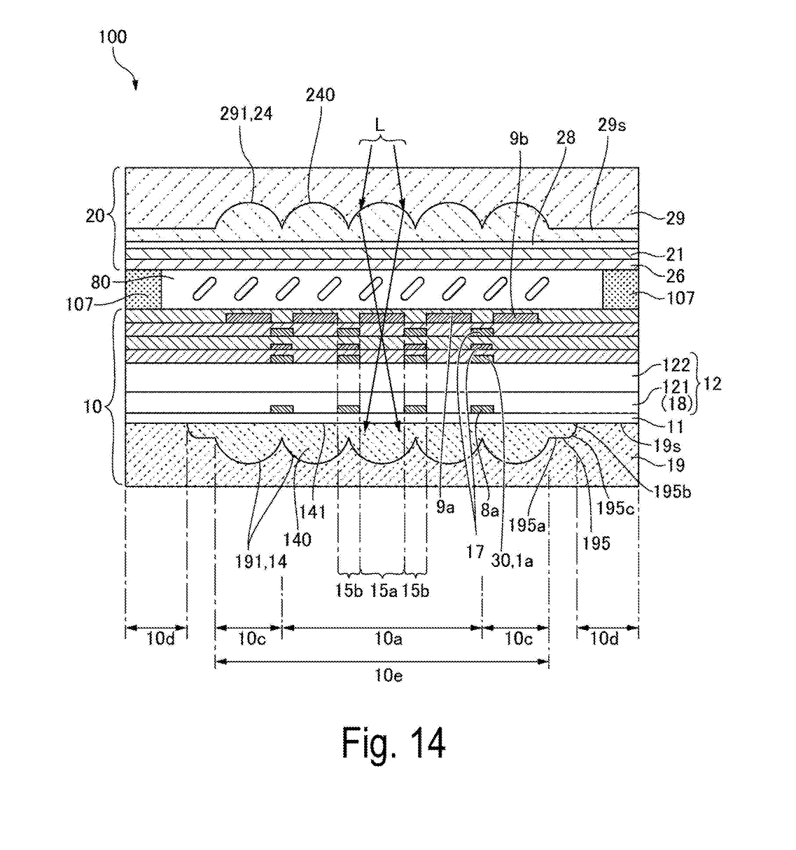

FIG. 14 is a diagram illustrating the barrier layer 18 of the electro-optical device 100 according to Exemplary Embodiment 7 of the disclosure. As illustrated in FIG. 14, in Exemplary Embodiment 7, the insulating film 12, which is formed between the lower light shielding layer 8a and the semiconductor layers 1a, includes stacked films including a first layer 121 and a second layer 122. The second layer 122 is stacked on an opposite side of the first substrate 19 with respect to the first layer 121. The second layer 122 and the light transmissive layer 11 each include a silicon oxide film. The first layer 121 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Exemplary Embodiment 8

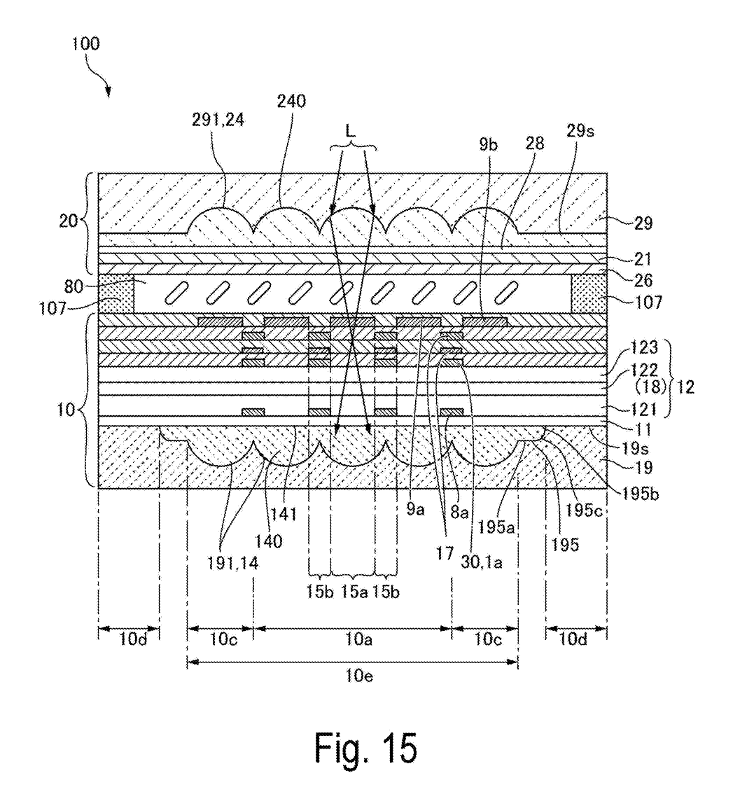

FIG. 15 is a diagram illustrating the barrier layer 18 of the electro-optical device 100 according to Exemplary Embodiment 8 of the disclosure. As illustrated in FIG. 15, in Exemplary Embodiment 8, the insulating film 12, which is formed between the lower light shielding layer 8a and the semiconductor layers 1a, includes stacked films including a first layer 121, a second layer 122, and a third layer 123. The second layer 122 is stacked on an opposite side of the first substrate 19 with respect to the first layer 121. The third layer 123 is stacked on an opposite side of first substrate 19 with respect to the second layer 122. The first layer 121, the third layer 123, and the light transmissive layer 11 each include a silicon oxide film. The second layer 122 is configured as the barrier layer 18 and includes a silicon nitride film. The thickness of the barrier layer 18 is 10 nm or more. This configuration also produces advantages, similar to advantages of Exemplary Embodiment 1. For example, even when a heat treatment at a temperature of approximately 1000° C. or higher is performed to form layers such as the semiconductor layers 1a (polysilicon film) of the switching elements 30 and the first gate insulating layer 2a (thermal oxide film), escape of nitrogen from the lens layer 140 is prevented by the barrier layer 18.

### Other Exemplary Embodiments

In the exemplary embodiments described above, the lenses 24 are formed in the counter substrate 20 and the lenses 14 are formed in the element substrate 10. However, the disclosure may be applied to a configuration in which the lenses 14 are formed in the element substrate 10 and no lenses are formed in the counter substrate 20.

In the exemplary embodiments described above, a single layer of the lenses 14 are formed in the element substrate 10. However, the disclosure may be applied to a configuration in which, in the element substrate 10, lenses overlapping, in a plan view, with the lenses 14 and the pixel electrodes 9a are formed between the lenses 14 and the pixel electrodes 9a.

While the above-described exemplary embodiments are described assuming that light enters from the counter substrate 20 side, electro-optical devices 100 according to another exemplary embodiment may be used by allowing light to enter from the element substrate 10 side.

In the exemplary embodiments described above, the lenses 14 have a positive power. However, the disclosure may be applied to a configuration in which the lenses 14 have a negative power provided that the lens layer 140 of the lenses 14 includes a silicon oxynitride film. In such cases, the lens surfaces 191 are convex curved surfaces. In addition, in the exemplary embodiments described above, the entirety of each of the lens surfaces 191 is a curved surface. However, the disclosure may be applied to a configuration in which the bottom of the lens surfaces 191 is a flat surface.

In the exemplary embodiments described above, one barrier layer 18 is provided. However, a plurality of barrier layers 18 may be provided by combining any of the exemplary embodiments described above. In addition, by utilizing the barrier layer 18 including a silicon nitride film, formed between the lens layer 140 and the pixel electrodes 9a, an anti-reflection film may be formed by providing a multi-layer dielectric film including the barrier layer 18.

Example of Installation to Electronic Apparatus

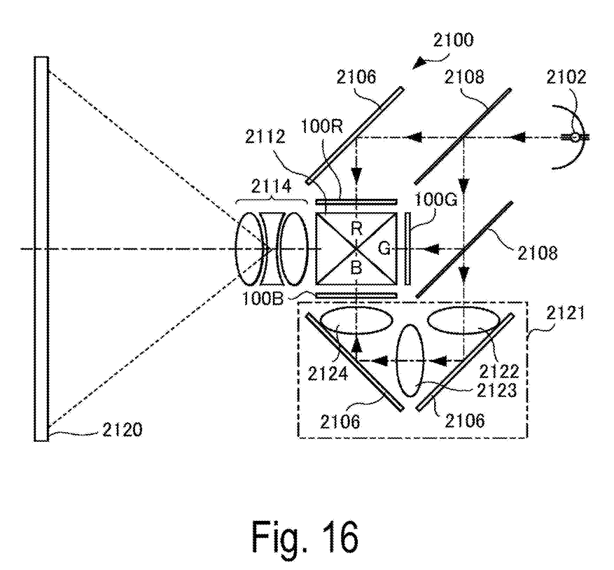

An electronic apparatus including the electro-optical device 100 according to the above-described exemplary embodiments will be described. FIG. 16 is a schematic configuration diagram of a projection display apparatus (electronic apparatus) including an electro-optical device 100, to which the disclosure is applied. A projection display apparatus 2100, illustrated in FIG. 16, is an example of an electronic apparatus including the electro-optical device 100. The electro-optical device 100 is used as a light valve in the projection display apparatus 2100 and enables a bright, high-resolution display without increasing the size of the apparatus. As illustrated in FIG. 16, a lamp unit 2102 (light source unit) is disposed within the projection display apparatus 2100. The lamp unit 2102 may be, for example, a halogen lamp and includes a white light source. Projection light emitted from the lamp unit 2102 is split into light components of three primary colors, red (R), green (G), and blue (B) by using three mirrors 2106 and two dichroic mirrors 2108, which are disposed within the apparatus. The split components of the projection light are respectively guided to corresponding light valves, 100R, 100G, and 100B, corresponding to the primary colors, and are modulated. The optical path length of the light component of B is longer than the optical path lengths of the light components of R and G. Thus, in order to prevent loss of the light component of B, the light component of B is guided through a relay lens system 2121, which includes an entrance lens 2122, a relay lens 2123, and an exit lens 2124.

The light components modulated by the respective light valves, 100R, 100G, and 100B, enter a dichroic prism 2112 from three directions. The light components of R and B are reflected at 90 degrees by the dichroic prism 2112 and the light component of G transmits through the dichroic prism 2112. Thus, after images of the respective primary colors are combined, a color image is projected on a screen 2120 by a projection lens group 2114 (projection optical system).

Another Projection Display Apparatus

Note that the projection display apparatus may have another configuration such that LED light sources, serving as light source units, for emitting respective colors are used, and the colors emitted from such LED light sources are supplied to different liquid display devices.

Other Electronic Apparatuses

The electronic apparatus including the electro-optical device 100, which includes the disclosure, is not limited to the projection display apparatus 2100 of the exemplary embodiments described above. Examples of the electronic apparatus include projection-type head-up displays (HUDs), direct-view head-mounted displays (HMDs), personal computers, digital still cameras, liquid crystal televisions, and other electronic apparatuses.

What is claimed is:

1. A substrate for an electro-optical device, the substrate comprising:
a first substrate;
a pixel electrode on a first surface of the first substrate;
a switching element between the first substrate and the pixel electrode, the switching element including a semiconductor layer;
a lens between the first substrate and the semiconductor layer, the lens overlapping, in a plan view, with the pixel electrode; and
a barrier layer between the lens and the semiconductor layer.

2. The substrate for the electro-optical device according to claim 1, wherein
the lens includes a lens layer, and
the lens layer includes a silicon oxynitride film.

3. The substrate for the electro-optical device according to claim 1, wherein
the barrier layer includes one of a silicon nitride film, an aluminum oxide film, or a hafnium oxide film.

4. The substrate for the electro-optical device according to claim 3, wherein
the barrier layer includes a silicon nitride film.

5. The substrate for the electro-optical device according to claim 1, wherein
the barrier layer is disposed on a surface of the lens on an opposite side of the first substrate.

6. The substrate for the electro-optical device according to claim 1, further comprising
a light shielding layer disposed in a layer between the barrier layer and the semiconductor layers.

7. The substrate for an electro-optical device according to claim 1, wherein
the barrier layer has a thickness of at least 10 nm.

8. The substrate for an electro-optical device according to claim 1, further comprising
an anti-reflection film between the lens and the pixel electrode, the anti-reflection film including a multi-layer dielectric film including the barrier layer.

9. An electro-optical device comprising:
the substrate for the electro-optical device according to claim 1;
a counter substrate, the counter substrate including:
a second substrate facing the substrate for the electro-optical device; and
a common electrode on a surface of the second substrate, the surface facing the substrate for the electro-optical device; and
an electro-optical layer between the substrate for the electro-optical device and the counter substrate.

10. An electronic apparatus comprising the electro-optical device according to claim 9.

11. A substrate for an electro-optical device, the substrate comprising:
a first substrate;
a pixel electrode on a first surface of the first substrate;
a switching element between the first substrate and the pixel electrode, the switching element including a semiconductor layer;
a lens between the first substrate and the semiconductor layer, the lens overlapping, in a plan view, with the pixel electrode; and
a silicon nitride film between a lens layer and the semiconductor layer.

12. The substrate for the electro-optical device according to claim 11, the substrate further comprising:
a light shielding layer between the lens layer and the semiconductor layer, wherein
the silicon nitride film is disposed on a location overlapping, in a plan view, with the light shielding layer, and has an island shape.

13. A substrate for an electro-optical device, the substrate comprising:
a first substrate;
a pixel electrode on a first surface of the first substrate;
a switching element between the first substrate and the pixel electrode, the switching element including a semiconductor layer;
a lens between the first substrate and the semiconductor layer, the lens overlapping, in a plan view, with the pixel electrode; and
an aluminum oxide film between a lens layer and the semiconductor layer.

14. The substrate for the electro-optical device according to claim 13, the substrate further comprising:
a shielding layer between the lens layer and the semiconductor layer, wherein
the aluminum oxide film is disposed on a location overlapping, in a plan view, with the light shielding layer, and has an island shape.
